(19) United States
(12) Patent Application Publication
(10) Pub. No.: US 2026/0106875 A1
(43) Pub. Date: Apr. 16, 2026

(54) EPHEMERAL PRIVILEGED ACCESS WORKSTATION

(71) Applicant: Oracle International Corporation, Redwood Shores, CA (US)

(72) Inventors: Jie Yuan, Fulshear, TX (US); Srujan Jonnadula, Seattle, WA (US); Puneet Sharma, Austin, TX (US); Achal Prakashbhai Velani, Bellevue, WA (US); Nidheesh Dubey, Union City, CA (US); Siddharth Sathish Shenoy, Sammamish, WA (US); Jeremiah David Small, Westford, MA (US); Apurv Awasthi, Woodinville, WA (US); Harsh Aseeja, Kirkland, WA (US); Umesh Ravuru, Cumming, GA (US); Mark Garrick Thurston, Austin, TX (US); Nirmal Kumar, Gurgaon (IN); Nikhil Kumar Singh, New Delhi (IN); Bryce Austin Turley, Hawthorne, CA (US); Douglas Robert Chivers, Hereford (GB); Robert Graham Clark, Aberystwyth (GB)

(73) Assignee: Oracle International Corporation, Redwood Shores, CA (US)

(21) Appl. No.: 18/913,844

(22) Filed: Oct. 11, 2024

(51) Int. Cl. H04L 9/40

(52) U.S. Cl. CPC H04L 63/107; H04L 63/0823; H04L 63/20

(57) ABSTRACT

A framework for establishing ephemeral privileged access workstations for providing access to production workstations is described. For example, an ephemeral privileged access workstation may be provisioned just in time at a request from a client device for accessing a production workstation.

### BACKGROUND

A cloud service provider (CSP) provides a variety of services to users or customers on demand using different systems and infrastructure services. The CSP provides infrastructure services that can be used by customers to build their own networks and deploy customer resources. In some instances, the customer may utilize the CSP to provide access to production workstations of the customer. For example, the customer may utilize a client device to request access via the CSP to production workstations for various reasons, such as debugging issues in production.

Legacy approaches for using a CSP to provide access to production workstations provided for direct access between the client device of the customer and the production workstations, such as via a secure shell (SSH) connection. The connections were often unregulated, uninterrupted, and could be long lived. To provide security for the production workstations, the customer was often forced to purchase separate devices dedicated only for the use of accessing the production workstations.

### SUMMARY

The present disclosure relates generally to a framework for establishing an ephemeral privileged access workstation (EPAW) for facilitating access to production workstations for client devices. Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the detailed description section, and further description is provided therein.

An aspect of the present disclosure is directed to a method of hosting an ephemeral privileged access workstation via a cloud infrastructure provider system for providing access to a production workstation. The method may include receiving a request from a client device to access the production workstation, and determining a container image corresponding to the client device responsive to receiving the request, the container image including configurations and policies for accessing the production workstation. The method may further include, responsive to receiving the request, provisioning the container image within the cloud infrastructure provider system to establish the ephemeral privileged access workstation, and establishing a connection between the ephemeral privileged access workstation and the production workstation for the client device. Further, the method may include monitoring inputs into the ephemeral privileged access workstation from the client device for the production workstation, and storing the inputs in a location outside of the ephemeral privileged access workstation. The method may further include determining that the connection between the ephemeral privileged access workstation and the production workstation is to be terminated, and responsive to determining that the connection is to be terminated, deprovisioning the container image within the cloud infrastructure provider system to terminate the ephemeral privileged access workstation.

An aspect of the present disclosure is directed to one or more computer-readable media having instructions stored thereon, wherein the instructions, when executed by one or more processors of a cloud infrastructure provider system, cause the one or more processors to perform operations. The one or more processors may receive a request from a client device to access a production workstation, and determine a container image corresponding to the client device responsive to receiving the request, the container image including configurations and policies for accessing the production workstation. Responsive to receiving the request, the one or more processors may provision the container image within the cloud infrastructure provider system to establish an ephemeral privileged access workstation that provides access to the production workstation. Further, the one or more processors may establish a connection between the ephemeral privileged access workstation and the production workstation for the client device. The one or more processors may further monitor inputs into the ephemeral privileged access workstation from the client device for the production workstation, and store the inputs in a location outside of the ephemeral privileged access workstation. The one or more processors may determine that the connection between the ephemeral privileged access workstation and the production workstation is to be terminated. Responsive to determining that the connection is to be terminated, the one or more processors may deprovision the container image within the cloud infrastructure provider system to terminate the ephemeral privileged access workstation.

An aspect of the present disclosure is directed to a cloud infrastructure provider system. The cloud infrastructure provider system may include a gateway accessible by a client device for providing access to the cloud infrastructure provider system, and one or more processors coupled to the gateway. The one or more processors may receive a request from the client device to access a production workstation, and determine a container image corresponding to the client device responsive to receiving the request, the container image including configurations and policies for accessing the production workstation. Responsive to receiving the request, the one or more processors may provision the container image within the cloud infrastructure provider system to establish an ephemeral privileged access workstation that provides access to the production workstation. Further, the one or more processors may establish a connection between the ephemeral privileged access workstation and the production workstation for the client device. The one or more processors may further monitor inputs into the ephemeral privileged access workstation from the client device for the production workstation, and store the inputs in a location outside of the ephemeral privileged access workstation. Further, the one or more processors may determine that the connection between the ephemeral privileged access workstation and the production workstation is to be terminated. Responsive to determining that the connection is to be terminated, the one or more processors may deprovision the container image within the cloud infrastructure provider system to terminate the ephemeral privileged access workstation.

The foregoing, together with other features and embodiments will become more apparent upon referring to the following specification, claims, and accompanying drawings.

### BRIEF DESCRIPTION OF THE DRAWINGS

Features, embodiments, and advantages of the present disclosure are better understood when the following Detailed Description is read with reference to the accompanying drawings.

FIG. 1 illustrates an example system arrangement, according to at least one embodiment.

FIG. 2 illustrates an example cloud infrastructure provider system arrangement, according to at least one embodiment.

FIG. 3 illustrates a first portion of an example system operation arrangement, according to at least one embodiment.

FIG. 4 illustrates a second portion of the example system operation arrangement, according to at least one embodiment.

FIG. 5 illustrates a portion of an example system arrangement, according to at least one embodiment.

FIG. 6 illustrates another portion of an example system arrangement, according to at least one embodiment.

FIG. 7 illustrates an example system arrangement, according to at least one embodiment.

FIG. 8 illustrate an example procedure for providing access to production workstations via EPAWs, according to at least one embodiment.

FIG. 9 is a block diagram illustrating one pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

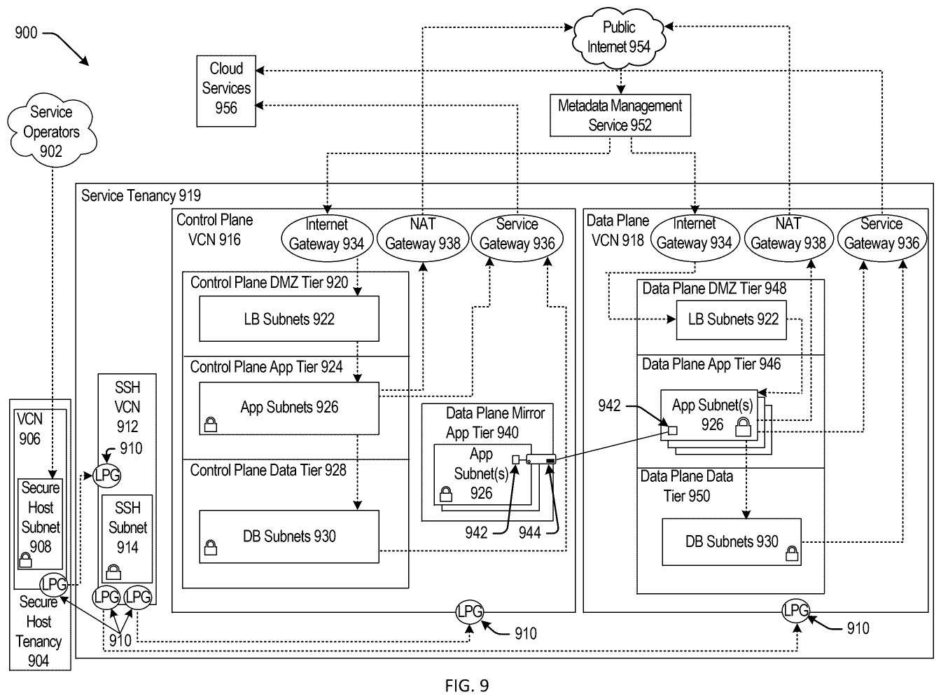

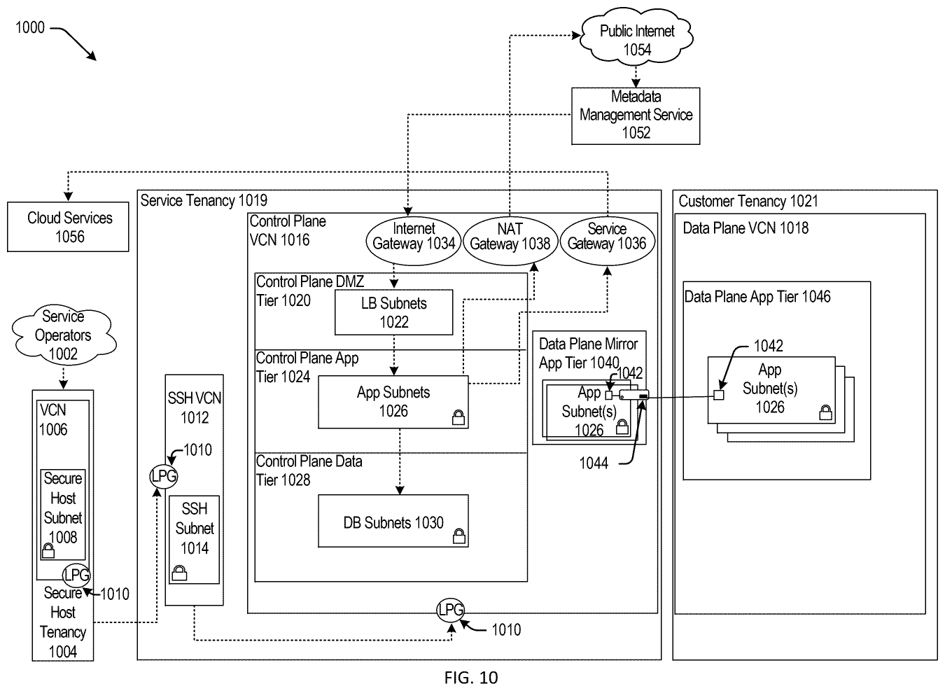

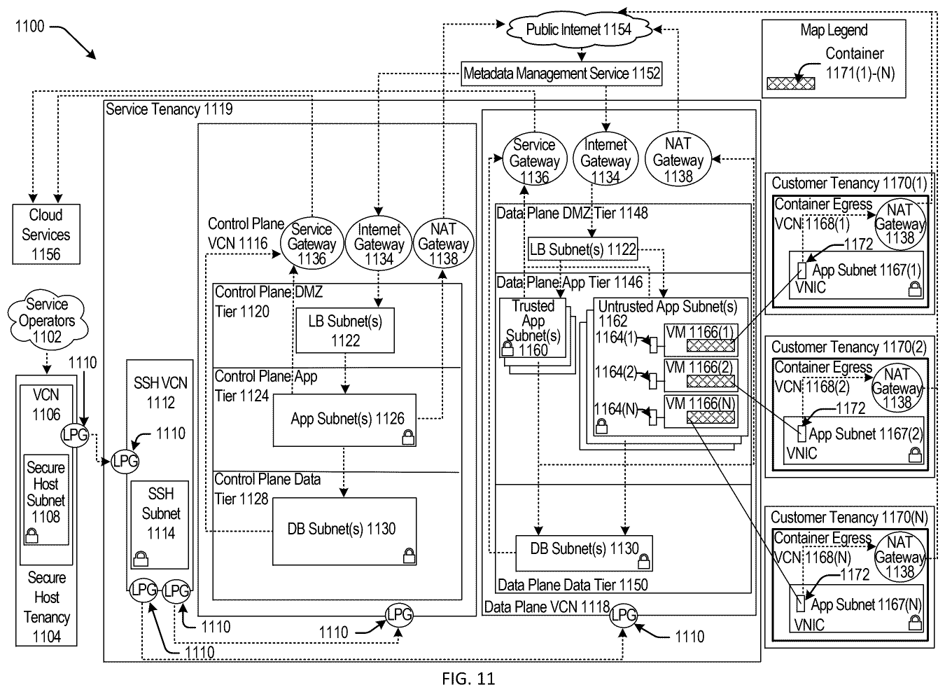

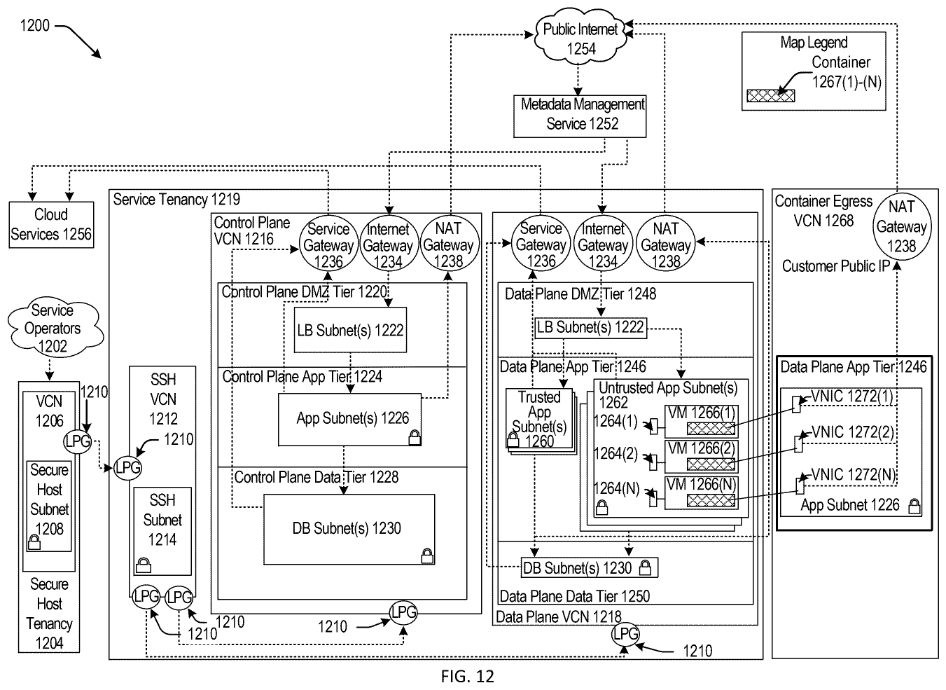

The present disclosure describes techniques for providing access to production workstations of a customer via an ephemeral privileged access workstation (EPAW). The EPAW may be hosted on an infrastructure (such as a cloud infrastructure service, e.g., the internet as a service (IaaS) architecture of FIG. 9, the IaaS architecture of FIG. 10, the IaaS architecture of FIG. 11, and/or the IaaS architecture of FIG. 12) that can allow client devices to access corresponding production workstations via the infrastructure. For example, the client devices can access the EPAW via the infrastructure and the EPAW can provide tools for the production workstations. The tools provided by the EPAW can be predefined and limited to tools that have been approved for use with the production workstations.

The EPAW can be provisioned on the fly. For example, the EPAW can be provisioned on the infrastructure at approximately a same time that a request for access to the production workstations is received. Additionally, the EPAW can be deprovisioned when the established session with the production workstations is ended. The EPAW being provisioned at the time of request and deprovisioned when the session ends, along with other features described throughout this disclosure, can limit security risks that can introduced when accessing the production workstations.

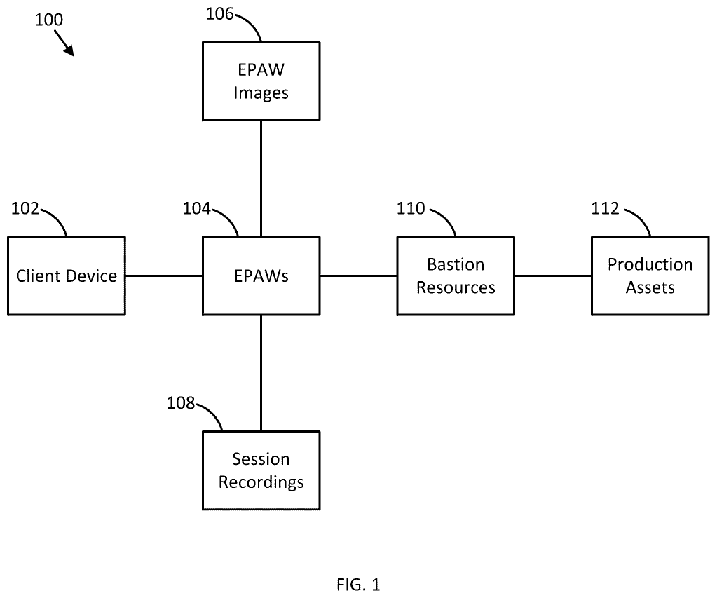

FIG. 1 illustrates an example system arrangement 100, according to at least one embodiment. The system arrangement 100 illustrates an example arrangement of elements for providing access to production workstations via an EPAW in accordance with some embodiments. Elements of the system arrangement 100 may be implemented by a CSP, as described further throughout this disclosure.

The system arrangement 100 may include one or more client devices 102. The client devices may be operated by one or more users corresponding to customers of a CSP. The client devices 102 may be computing devices that are connected to the internet and/or a network for communicating with the CSP. There may be no special restrictions for the client devices 102 to access the production workstations via the EPAW. For example, legacy approaches may require client devices to have limited use for security when accessing production workstations, including being limited from loading programs onto the client devices, accessing the internet and/or other networks via the client devices, and/or connecting external devices to the client devices. The EPAW may provide isolation between the client devices 102 and the production workstations such that the client devices 102 do not require the same limitations as to use as the legacy client devices.

The system arrangement 100 may include one or more EPAWs 104. The EPAWs 104 may be containerized virtual machines. The EPAWs 104 may be hosted by a cloud infrastructure provider system, such as being hosted in a subnet of the cloud infrastructure provider system. Each of the EPAWs 104 may be provisioned on request of a session and may be deprovisioned at termination of the session.

The system arrangement 100 may include an image store 106. The image store 106 may store one or more EPAW images. The EPAW images may be container images that can be utilized for establishing EPAWs. The EPAW images can provisioned to a cloud infrastructure provider system to establish one or more EPAWs, such as the EPAWs 104. Each of the EPAW images stored in the image store 106 may correspond to a customer, a user, a user group, a client device, and/or a client device group. The image store 106 may be hosted in a different subnet of the cloud infrastructure provider system from the subnet that is hosting the EPAWs 104.

The system arrangement 100 may further include a sessions recording store 108. The sessions recording store 108 may store one or more session recordings from EPAW sessions, such as sessions of the EPAWs 104. For example, a session recording stored in the sessions recording store 108 may include recorded inputs and/or outputs of a session of an EPAW. The sessions recording store 108 may be hosted in a different subnet of the cloud infrastructure provider system. The client devices 102 may not be able to access the session recordings in the session recordings store 108 that can prevent bad actors from attempting to alter the session recordings.

The system arrangement 100 may further include one or more bastion resources 110 and one or more corresponding production assets 112. The bastion resources 110 may provide restricted and/or time-limited secure access to the production assets 112. The production assets 112 may be accessed by corresponding users and/or client devices, and may be utilized to perform one or more operations with one or more production workstations.

Each of the client devices 102 may be capable of establishing a connection with a corresponding EPAW of the EPAWs 104. For example, a client device of the client devices 102 may transmit a request for a connection to a production workstation and/or establishment of a corresponding EPAW of the EPAWs 104. The request may include authentication information for the EPAW. The client device may transmit the request to the cloud infrastructure provider system that hosts the EPAWs.

The cloud infrastructure provider system may receive the request from the client device. In embodiments where the request includes authentication information, the cloud infrastructure provider system may authenticate the client device and/or determine whether the client device is authorized to access the production workstation.

If the cloud infrastructure provider system determines that the client device is authorized to access the production workstation, the cloud infrastructure provider system may identify an EPAW image, from the EPAW images within the image store 106, corresponding to the client device. The cloud infrastructure provider system may provision the identified EPAW image to establish an EPAW, from the EPAWs 104, to be utilized by the client device. The EPAW may be established just in-time. For example, the EPAW may be established in response to the request and/or the determination that the client device is authorized to access the production workstation, where the EPAW does not exist on the cloud infrastructure provider system prior to the request. Once the EPAW has been established, an identifier (ID) can be assigned for accessing the EPAW and can be shared with the client device for accessing the EPAW.

The EPAW may establish a connection with one or more distinct protected production environments, such as the bastion resources 110. The EPAW may provide the client device with services of one or more protected production environments via the bastion resources 110. The EPAW may include tools for utilizing the production assets. The tools of the EPAW may be limited to tools approved for use with the production assets. The client device may be prevented from adding, removing, and/or altering the tools of the EPAW. Further, the EPAW may not have access to the internet, which can prevent changes to the tools from the internet, such as the client device downloading tools from the internet to the EPAW.

The client device may establish a connection with the established EPAW. For example, the client device may utilize the shared ID to establish a connection with the EPAW. In some embodiments, the client device may provide a secure shell (SSH) key to the EPAW for signing into the EPAW. The EPAW may utilize an SSH certificate authority (CA) to check the SSH key and verify that the client device has authorization to utilize the EPAW. The EPAW may limit access to the client device that requested establishment of the EPAW. A session may be initiated between the client device and the EPAW when the client device establishes a connection with the EPAW.

Once the client device has established the connection with the EPAW, the client device 102 may exchange data with the EPAW. The system arrangement 100 may include a monitoring element that can record data, actions, and/or operations exchanged between the client device and the EPAW. For example, the monitoring element may record key entries at the client device related to the EPAW, data transmitted from the client device to the EPAW, and/or data transmitted from the EPAW to the client device. The monitoring element may generate a session recording for recorded information and store the session recording in the session recordings store 108. In some embodiments, the monitoring element may be a relay device located between the client device and the EPAW, where the relay device is located in a different subnet from the EPAW.

The cloud infrastructure provider system may determine that the session between the client device and the EPAW is to be terminated. The cloud infrastructure provider system may determine the session is to be terminated based on a request to the terminate the session received from the client device, a user of the client device signing out of the client device and/or the EPAW, an expiry of an inactivity time of the session, and/or another reason for termination of the session defined by an administrator of the cloud infrastructure provider system. The cloud infrastructure provider system may deprovision EPAW image to terminate the EPAW based on the cloud infrastructure provider system determining that the session is to be terminated. Accordingly, the EPAW may be terminated when the session ends, such that the EPAW does not exist and is inaccessible after the session has been terminated.

The EPAWs 104 can provide advantages over legacy approaches where a client device connects directly to bastions (such as the bastion resources 110 and/or the bastion). As an example, the EPAWs 104 can present higher security (including the EPAWs 104 not having an internet connection) than the direct bastion connections of legacy approaches, where the direct bastion connections could cause viruses on the client devices to be passed to the bastions and/or the production workstation. Additionally, the cloud infrastructure provider system terminating the EPAWs 104 at the termination of a corresponding session can terminate a connection point to a production workstation, where leaving the connection point to the bastions available in the legacy approaches could allow bad actors to establish a connection with the production workstation via the connection point after the client device has terminated a session. Further, the cloud infrastructure provider system determining to terminate the EPAWs 104 at the expiry of an inactivity time can prevent client devices from maintaining an open connection that could be a weak point that bad actors could take advantage of.

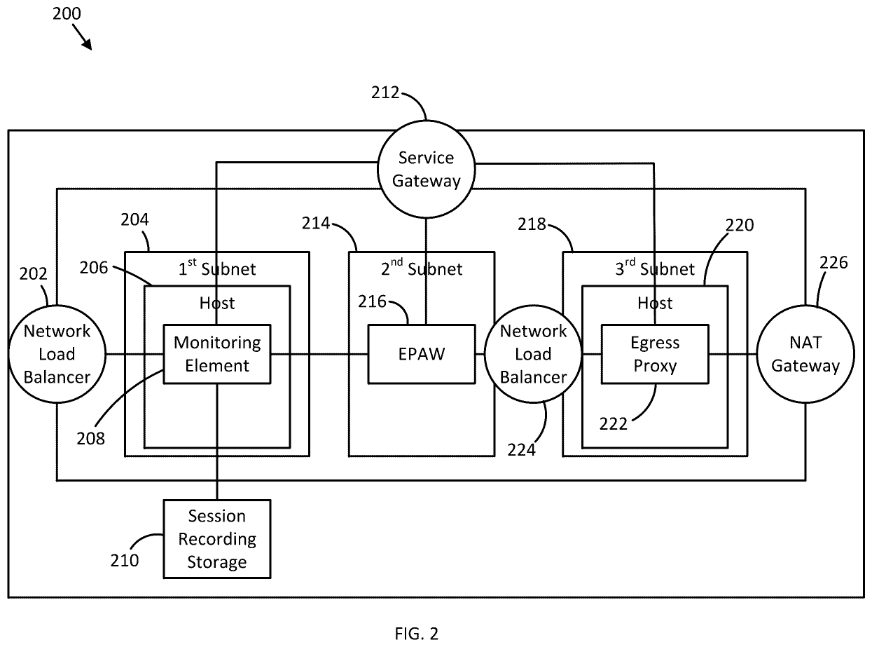

FIG. 2 illustrates an example cloud infrastructure provider system arrangement 200, according to at least one embodiment. The arrangement 200 illustrates an example of a cloud infrastructure provider system that implements EPAW in accordance with some embodiments. The arrangement 200 may be utilized by a client device to access a production workstation.

The arrangement 200 may include a network load balancer 202. In some embodiments, the network load balancer 202 may be located at an edge of a virtual cloud network (VCN). The network load balancer 202 may provide a connection point for client devices to connect to the VCN. The network load balancer 202 may receive transmissions from the client devices and direct the transmissions to the appropriate portions of the VCN. The client devices may access the network load balancer 202 through a corresponding console, an internet access point (such as a webpage), a user command line, or some combination thereof.

The arrangement 200 may include a first subnet 204. The first subnet 204 may operate a host 206. The host 206 may correspond to one or more particular subscribers, where transmissions from client devices associated with the one or more subscribers may be directed to the host 206. The host 206 may define who can login to the first subnet 204 and/or an EPAW in a second subnet 214.

The host 206 may include a monitoring element 208. In some embodiments, the monitoring element 208 may be a relay device agent. The monitoring element 208 may be coupled to the network load balancer 202. The monitoring element 208 may record session information for devices coupled to the network load balancer 202. For example, the monitoring element 208 may receive transmissions to and from the network load balancer 202, and may store copies of the received transmissions. In some embodiments, the monitoring element 208 may further capture keystrokes of client devices coupled to the network load balancer 202 and store indications of the keystrokes.

The monitoring element 208 may determine whether client devices connecting to the host 206 are authorized for access. A client device may request a secure shell-certificate authority (SSH-CA) certificate from the monitoring element 208. The client device may provide credentials with the request, where the monitoring element 208 may determine whether the client device has authorization for accessing an EPAW and/or may determine which EPAW corresponds to the client device. In some embodiments, the credentials may include a secure shell (SSH) protocol certificate. The arrangement 200 may include a service gateway 212 that the monitoring element 208 may utilize for authenticating the SSH certificate. If the monitoring element 208 determines that the client device is authorized for accessing an EPAW, the monitoring element 208 may generate a second SSH protocol certificate. In some embodiments, the second SSH protocol certificate may have an expiration time, where the public key will no longer provide access to the EPAW after expiry of the expiration time.

The arrangement 200 may include session recording storage 210. The session recording storage 210 may include memory of the VCN. The session recording storage 210 may be located outside of the first subnet 204. The monitoring element 208 may store the captured session information in the session recording storage 210. The session recording storage 210 being separate from the first subnet 204 may provide protection from unauthorized access. For example, client devices may be authorized to access to access the host, but may be prevented from accessing the session recording storage 210. Access to the session recording storage 210 may be limited to authorized operators of the VCN. Based on the limited access to the session recording storage 210, there is little risk that the stored session information will be tampered with.

The arrangement 200 may include a second subnet 214. The second subnet 214 may be separate from the first subnet 204 and may provide some isolation from the first subnet 204. For example, the second subnet 214 may require a different certificate than the first subnet 204 for access, such that a certificate utilized for accessing the first subnet 204 cannot be utilized for accessing the second subnet 214 and a certificate utilized for accessing the second subnet 214 cannot be utilized for accessing the first subnet 204.

The second subnet 214 may operate one or more EPAWs, such as EPAW 216. The EPAW 216 may be ephemeral, where each of the EPAW 216 may be provisioned upon request and deprovisioned when a connection is terminated. For example, the monitoring element 208 may transmit a request for the EPAW 216 to the second subnet 214. The request may include the second SSH certificate generated by the monitoring element 208 based on the request from the client device. The second subnet 214 may identify a container image corresponding to the client device based on the request and/or the second SSH certificate. For example, the second subnet 214 may utilize the service gateway 212 to access a container image store (such as the image store 106 (FIG. 1)) and identify the container image corresponding to the client device stored in the container image store. The second subnet 214 may provision the container image within the second subnet 214 to establish the EPAW 216 for the client device.

The container image may define tooling for the EPAW 216. When the container image is provisioned establishing the EPAW 216, the established EPAW 216 may have the tooling defined by the container image. The EPAW 216 may not have access to the internet, which can prevent tools from being added to the EPAW 216 and/or from unauthorized actors from accessing the EPAW 216. Further, the client devices may be prevented from adding and/or removing tools from the EPAW 216. Limiting tools of the EPAW 216 to the tools defined by the container image can prevent unauthorized tools and/or bad actor tools from being added to the EPAW 216 and/or performing unauthorized actions with production machines.

An administrator may set up configuration values in the abstract for the EPAW 216. The configuration values may define operations that can be performed with the EPAW 216 and/or rules for the EPAW 216. For example, the configuration values can be used for setting up policies as to which data may be imported and/or exported from the EPAW 216. In some instance, the configuration values may set a rule that nothing can be copied from the EPAW 216. Setting rules to prevent data from being copied from the EPAW 216 may prevent data from being copied and/or removed from a secured area.

Once the EPAW 216 is established, the EPAW 216 may be assigned an identifier (ID), such as a cloud ID. For example, the host 206 and/or the monitoring element 208 may assign the ID to the EPAW 216. The ID may be utilized for addressing the EPAW 216. The ID for the EPAW 216 may be shared with the client device, where the client device may utilize the ID to address the EPAW 216.

The arrangement 200 may include a third subnet 218. The third subnet 218 may be separate from the first subnet 204 and the second subnet 214, and may provide some isolation from the first subnet 204 and the second subnet 214. For example, the third subnet 218 may require a different certificate than the first subnet 204 and the second subnet 214 for access. In some embodiments, a network load balancer 224 located between the second subnet 214 and the third subnet 218 that can facilitate propagation of transmissions between the second subnet 214 and the third subnet 218.

The third subnet 218 may operate a host 220. The host 220 may correspond to one or more production workstations, where communications with the production workstations may propagate through the host 220. The host 220 may define which EPAWs can access the corresponding production workstations.

The host 220 may include an egress proxy 222. Access to the egress proxy 222 may be limited to EPAWs, such as the EPAW 216. The egress proxy 222 may be the only element within the arrangement 200 that has the permission to connect to the production workstations. The egress proxy 222 may be able to connect to a bastion, such as via a network address translation (NAT) gateway 226, where the bastion controls access to the production work stations. The egress proxy 222 may use an identifier of the egress proxy to access the bastion. In some embodiments, the bastion may be omitted and the NAT gateway 226 may provide the connection to the production workstations.

Once an EPAW session of the EPAW 216 is terminated, the EPAW 216 may be deprovisioned. The EPAW session may be terminated based on a user request to terminate the EPAW session. In some embodiments, an EPAW session may be further configured to terminate based on other conditions. Some of the other conditions may include expiration of an inactivity timer, completion of a defined operation or defined operations, disconnection of the client device, or some combination thereof. Deprovisioning the EPAW 216 may result in the EPAW 216 ceasing to exist, releasing the resources executing the EPAW 216, erasing data generated and/or modified by the EPAW 216, or some combination thereof. The EPAW 216 being deprovisioned may prevent bad actors from accessing the production workstations via the EPAW 216, and/or accessing data generated and/or modified by the EPAW 216.

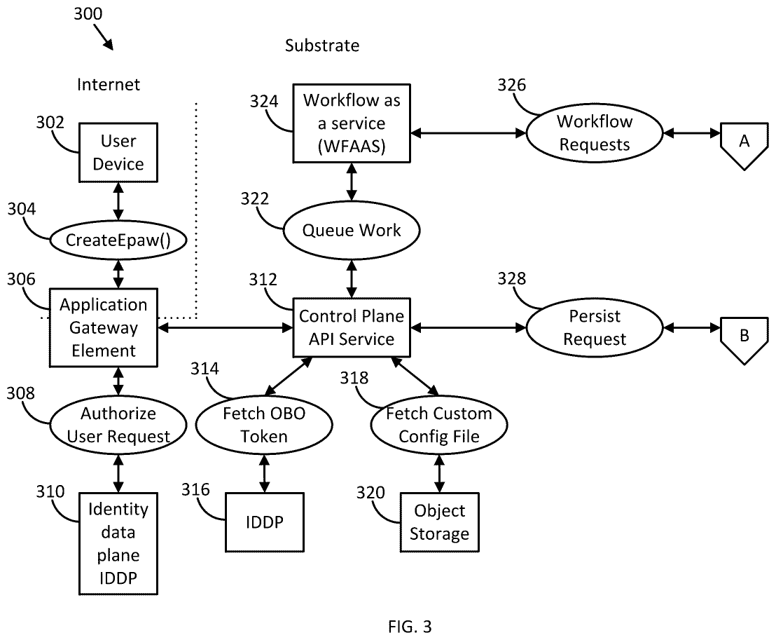

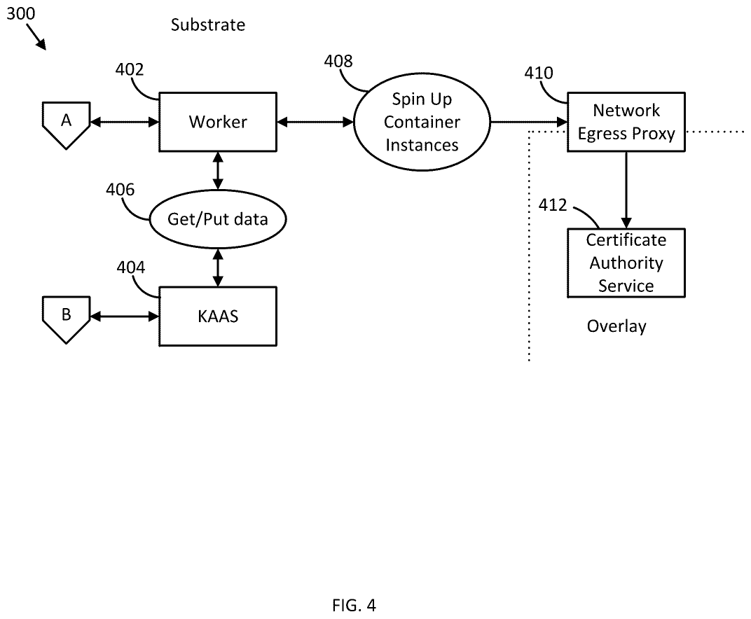

FIG. 3 illustrates a first portion of an example system operation arrangement 300, according to at least one embodiment. FIG. 4 illustrates a second portion of the example system operation arrangement 300, according to at least one embodiment. The system operation arrangement 300 illustrates a flow for provisioning an EPAW in accordance with some embodiments. For example, one or more of the operations illustrated and/or described in relation to the system operation arrangement 300 may be performed to provision for a client device.

The system operation arrangement 300 may include a user device 302. The user device 302 may include one or more of the features of the client device 102 (FIG. 1). The user device 302 may be part of an internet portion of the system operation arrangement 300. Elements in the internet portion may be located remote to a cloud service provider and may utilize the internet to communicate with the cloud service provider.

The user device 302 may generate and/or transmit an EPAW creation request 304. The EPAW creation request 304 may request that an EPAW be provisioned for the user device 302 to allow the user device 302 to access one or more production workstations. A user of the user device 302 may utilize command line to request that the user device 302 generate and/or transmit the EPAW creation request 304. The EPAW creation request 304 may include an identifier of the user device 302, an identifier of a user of the user device 302, one or more credentials for determining whether the user device 302 and/or the user is authorized to access the production workstations, or some combination thereof.

The system operation arrangement 300 may include an application gateway element 306. The application gateway element 306 may be part of a protected network portion of the system operation arrangement 300, where the application gateway element 306 may determine which users and/or user devices are authorized to access the protected network portion. The protected network portion of the system operation arrangement may include elements and/or operations of a cloud service provider.

The application gateway element 306 may receive the EPAW creation request 304. The application gateway element 306 may determine whether the user device 302 and/or the user is authorized to access the requested workstations. For example, application gateway element 306 may utilize the identifier and/or the credentials from the EPAW creation request 304 to determine whether the user device 302 and/or the user is authorized to access the requested workstations. The application gateway element 306 may transmit an authorize user request 308 to an identity data plane (IDDP) 310 that requests that the IDDP 310 determine whether the user device 302 is authorized to access the requested workstations. The IDDP 310 may respond with an authentication response and application gateway element 306 may determine whether the user device 302 and/or the user is authorized to access the requested workstations based on the authentication response.

If the application gateway element 306 determines that the user device 302 and/or the user is authorized to access the requested workstations, the application gateway element 306 may forward the EPAW creation request 304 to a control plane application programming interface (API) service 312. The control plane API service 312 may fetch an on-behalf-of (OBO) token in 314 from an IDDP 316 for the user device 302. Further, the control plane API service 312 may fetch a custom configuration file in 318 from an object store 320.

The control plane API service 312 may transmit a queue work 322 to a workflow as a service (WFAAS) 324. The WFAAS 324 may forward one or more workflow requests 326 to a worker 402. Further, the control plane API service 312 may transmit a persist request 328 to a key as a service (KAAS) 404. The KAAS 404 may include a key and/or value store. The worker 402 may retrieve parameters needed for the requested EPAW in 406 from the KAAS 404.

The worker 402 may communicate with a container service for spinning up one or more container instances in 408 for producing the requested EPAW. The worker 402 may utilize the retrieved parameters to spin up the one or more container instances to produce the EPAW. The EPAW may include one or more of the features of the EPAWs 104 (FIG. 1) and/or the EPAW 216 (FIG. 2). Once the EPAW has been established, an indication can be provided to the user device 302 that the EPAW has been established.

The established EPAW may be coupled to a network egress proxy 410. The network egress proxy 410 may communicate with a certificate authority service 412. The certificate authority service 412 may couple to a bastion and/or a production workstation, and may facilitate communication between the user device 302 and the production workstation via the established EPAW.

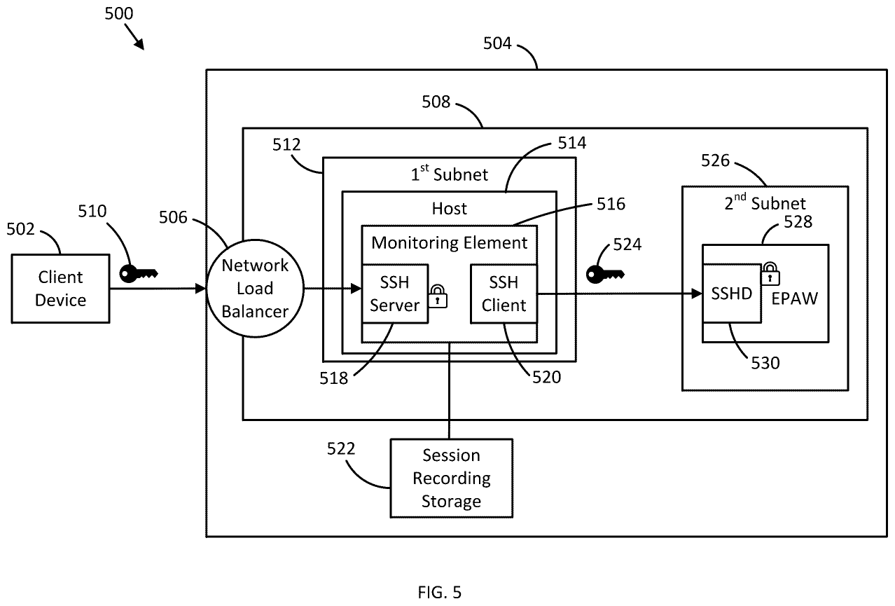

FIG. 5 illustrates a portion of an example system arrangement 500, according to at least one embodiment. In particular, the system arrangement 500 illustrates a portion of an example system implementing EPAWs in accordance with embodiments described throughout this disclosure. The illustrated system arrangement 500 illustrates example security that may be utilized in establishing an EPAW and/or accessing production workstations in accordance with some embodiments.

The system arrangement 500 may include a client device 502. The client device 502 may include one or more of the features of the client device 102 (FIG. 1), and/or the user device 302 (FIG. 3). A user of the client device 502 may request access to one or more production workstations via the client device 502. For example, a user may utilize command line features to request that the client device 502 establish connection with one or more production workstations. The user may input credentials into the client device 502 that may be utilized by the client device 502, and/or other elements of the system arrangement 500, to authenticate the user and/or determine whether the user is authorized to access the requested production workstations.

The system arrangement 500 may include a cloud service provider 504. The cloud service provider 504 may include hardware and/or software components that may be implemented as part of a cloud system, where the cloud service provider 504 may be accessed via the Internet in some embodiments. The client device 502 may establish a connection with portions of the cloud service provider 504.

The cloud service provider 504 may include a network load balancer 506. The network load balancer 506 may be located at an edge of an enclave 508 of the cloud service provider 504. The network load balancer 506 may be utilized for communicating with elements within the enclave 508.

The client device 502 may transmit a workstation access request and/or an EPAW establishment request to the network load balancer 506. The request may include a first key 510. The first key 510 may include data related to the client device 502 and/or the user of the client device 502 that can be utilized for determining whether the client device 502 and/or the user are authorized to access at least a portion of the cloud service provider 504.

The cloud service provider 504 may include a first subnet 512. The first subnet 512 may include one or more of the features of the first subnet 204 (FIG. 2). The first subnet 512 may include a host 514. The host 514 may include one or more features of the host 206 (FIG. 2). The host 514 may implement a monitoring element 516. The monitoring element 516 may include one or more of the features of the monitoring element 208 (FIG. 2).

The monitoring element 516 may include an SSH server 518 and an SSH client 520. The SSH server 518 may be utilized to determine whether the client device 502 and/or the user is authorized to access the first subnet 512. The SSH server 518 may receive the first key 510 and utilize the first key 510 to determine whether the client device 502 and/or the user is authorized to access the first subnet 512. If the SSH server 518 determines that the client device 502 is authorized to access the first subnet 512 based on the first key 510, the SSH server 518 can provide the client device 502 access to the first subnet 512. Otherwise, the SSH server 518 may prevent the client device 502 from accessing the first subnet 512.

If the SSH server 518 provides the client device 502 access to the first subnet 512, the monitoring element 516 may monitor data received from the client device 502 (such as keystrokes) and/or data transmitted to the client device 502. The monitoring element 516 may generate a session recording indicating the data and save the session recording in session recording storage 522 of the cloud service provider 504. The session recording storage 522 being separate from the first subnet 512 may prevent the client device 502 from accessing the session recording storage 522.

The SSH client 520 may generate a second key 524 if the client device 502 is allowed access to the first subnet 512. The second key 524 may be different from the first key 510. The client device 502 may not have access to the second key 524 and/or may not have the data to generate the second key 524. Not allowing the client device 502 to access the second key 524 may provide higher security for preventing bad actors from obtaining and/or using the second key 524.

The cloud service provider 504 may include a second subnet 526. The second subnet 526 may include one or more of the features of the second subnet 214 (FIG. 2). The second subnet 526 may establish and/or host an EPAW 528. The EPAW 528 may include one or more of the features of EPAWs 104 (FIG. 1) and/or the EPAW 216 (FIG. 2).

The EPAW 528 may include a secure shell daemon (SSHD) 530. The SSHD 530 may be utilized for determining which hosts and/or client devices are authorized for establishing and/or accessing the EPAW 528. The SSHD 530 may receive the second key 524 from the SSH client 520. The SSHD 530 may determine whether the host 514 and/or the client device 502 are authorized for establishing and/or accessing the EPAW 528 based at least in part on the second key 524. The SSHD 530 may allow the host 514 and/or the client device 502 to establish and/or access the EPAW 528 if the SSHD 530 determines that the host 514 and/or the client device 502 are authorized for establishing and/or accessing the EPAW 528. Otherwise, the SSHD 530 may prevent the host and/or the client device 502 from establishing and/or accessing the EPAW 528.

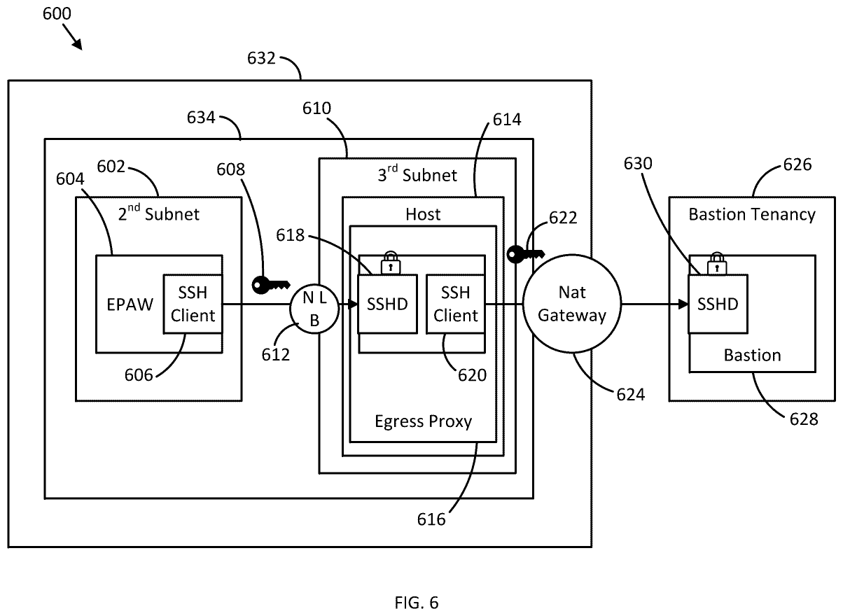

FIG. 6 illustrates another portion of an example system arrangement 600, according to at least one embodiment. In particular, the system arrangement 600 illustrates a portion of an example system that utilizes EPAWs to access production workstations via a base station. The illustrated system arrangement 600 illustrates example security that may be utilized for accessing a bastion that provides access to a production workstation.

The system arrangement 600 may include a cloud service provider 632. The cloud service provider 632 may include hardware and/or software components that may be implemented as part of a cloud system, where the cloud service provider 632 may be accessed via the Internet in some embodiments. The cloud service provider 632 may host an enclave.

The cloud service provider 632 may include a second subnet 602. The second subnet 602 may include one or more of the features of the second subnet 214 (FIG. 2) and/or the second subnet 526 (FIG. 5). The second subnet 602 may establish and/or host an EPAW 604. The EPAW 604 may include one or more of the features of the EPAWs 104 (FIG. 1), the EPAW 216 (FIG. 2), and/or the EPAW 528 (FIG. 5).

The EPAW 604 may include an SSH client 606. The SSH client 606 may generate a first key 608. The first key 608 may be unique to the EPAW 604. For example, the first key 608 may be different than the first key 510 (FIG. 5) and the second key 524 (FIG. 5). The first key 608 may include information that can be used to identify the EPAW 604 as the source of the first key 608. Access to the first key 608 may be limited to certain portions of a system. For example, a client device for which the EPAW 604 was established may be prevented from accessing the first key 608. Further, the first key 608 may be limited to the second subnet 602 and a third subnet 610. Limiting access to the first key 608 can provide for greater security than if more devices within the system had access to the first key 608, including limiting a number of devices from which a bad actor could obtain the first key 608.

The cloud service provider 632 may include the third subnet 610. The third subnet 610 may include one or more of the features of third subnet 218 (FIG. 2). The third subnet 610 may include a network load balancer 612. The network load balancer 612 may be located at an edge of the third subnet 610 and may facilitate communication with elements within the third subnet 610. The second subnet 602 may be coupled with the third subnet 610 via the network load balancer 612.

The third subnet 610 may include a host 614. The host 614 may include one or more of the features of the host 220 (FIG. 2). The host 614 may include an egress proxy 616. The egress proxy 616 may include one or more of the features of the egress proxy 222 (FIG. 2). The egress proxy 616 may facilitate communication of the EPAW 604 with one or more production workstations.

The host 614 may include an SSHD 618. The SSHD 618 may be utilized for determining which EPAWs are authorized for establishing and/or accessing the egress proxy 616. The SSHD 618 may receive the first key 608 from the SSH client 606. The SSHD 618 may determine whether the EPAW 604 is authorized for accessing the egress proxy 616 based at least in part on the first key 608. The SSHD 618 may allow the EPAW 604 to access the egress proxy 616 if the SSHD 618 determines that the EPAW 604 is authorized for accessing the EPAW 604. Otherwise, the SSHD 618 may prevent the EPAW 604 from accessing the egress proxy 616.

The host 614 may include an SSH client 620. The SSH client 620 may generate a second key 622 if the EPAW 604 is allowed access to the egress proxy 616. The second key 622 may be unique. For example, the second key 622 may be different from the first key 608. Further, the second key 622 may be different than other keys generated by a system, such as the first key 510 (FIG. 5) and/or the second key 524 (FIG. 5). The EPAW 604 may not have access to the second key 622 and/or may not have the data to generate the second key 622. Not allowing the EPAW 604 to access the second key 622 may provide higher security for preventing bad actors from obtaining and/or using the second key 622.

The system arrangement 600 may include a network address translation (NAT) gateway 624. The system arrangement 600 further includes a bastion tenancy 626. The NAT gateway 624 may be coupled between the third subnet 610 and the bastion tenancy 626. The NAT gateway 624 may facilitate communication between elements of the third subnet 610 (such as the egress proxy 616) and the bastion tenancy 626. For example, the egress proxy 616 may utilize the NAT gateway 624 to connect to the bastion tenancy 626, such as connecting through the internet.

The bastion tenancy 626 may include a bastion 628. The bastion 628 may establish connections to one or more production workstations, where the bastion 628 may communicate with the production workstations.

The bastion 628 may include an SSHD 630. The SSHD 630 may be utilized for determining which egress proxies are authorized for accessing the bastion 628. The SSHD 630 may receive the second key 622 from the SSH client 620. The SSHD 630 may determine whether the egress proxy 616 is authorized for accessing the bastion 628 based at least in part on the second key 622. The SSHD 630 may allow the egress proxy 616 to access the bastion if the SSHD 630 determines that the egress proxy 616 is authorized for accessing the bastion 628. Otherwise, the SSHD 630 may prevent the egress proxy 616 from accessing the bastion 628.

Once it has been determined that the egress proxy 616 is authorized to access the bastion 628, the bastion 628 may facilitate communication of the system with one or more production workstations. For example, a system may include a combination of the elements from the system arrangement 500 (FIG. 5) and/or the system arrangement 600. For example, a system may include the client device 502 (FIG. 5), the first subnet 512 (FIG. 5), a second subnet (which may include the features of the second subnet 526 (FIG. 5) and/or the second subnet 602), the third subnet 610, and/or the bastion tenancy 626. The system may facilitate communications and/or operations between the client device 502 and the production workstations. In particular, once access has been determined to be granted to all of the elements of the system based on the keys, the client device 502 may communicate via the system with one or more production workstations to allow the one or more production workstations to perform operations for the client device 502.

The system may continue to provide access between the client device 502 and the production workstations while the EPAW (such as the EPAW 528 (FIG. 5) and/or the EPAW 604) is maintained. As described throughout this disclosure, the EPAW may control the operations and/or tools that may be utilized between the client device 502 and/or the production workstations. Having the EPAW control the operations and/or tools that may be utilized between the client device 502 and the production workstations can protect against unauthorized operations from being performed by the production workstations and/or protect against unauthorized obtainment of data from the production workstations, among other protections that can be provided by not providing the client device 502 direct connection to the production workstations.

The system may terminate access between the client device 502 and the production workstations when the EPAW is terminated. The EPAW may be terminated in accordance with any of the EPAW termination operations described throughout this disclosure, including a user of the client device 502 terminating a session and/or expiry of an inactivity time of a session. When the EPAW has been terminated, the bastion 628 may no longer provide the client device 502 access to the production workstations.

Additionally, once the EPAW has been terminated, one or more of the keys may be determined to be expired and will no longer provide authorization for access to the corresponding elements. In particular, the first key 510 (FIG. 5) may be considered expired and will not provide access to the first subnet 512 (FIG. 5), the second key 524 may be considered expired and will not provide for establishment of a new EPAW, the first key 608 may be considered expired and will not provide access to the egress proxy 616, and/or the second key 622 may be considered expired and will not provide access to the bastion tenancy 626. The keys being considered expired may prevent any copies of the keys obtained by bad actors from being used to establish an EPAW and/or accessing the production workstations. If the client device 502 requests establishment of another session, new versions of one or more of the keys may be generated for establishing a new session.

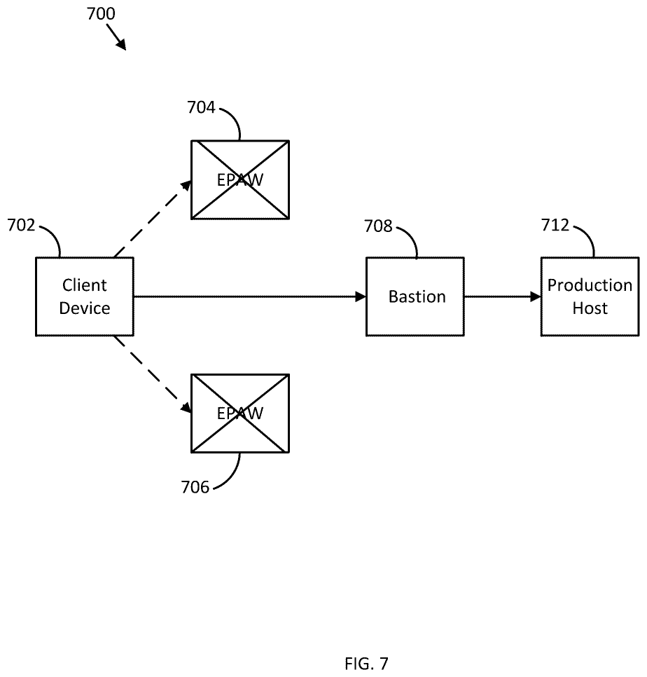

If the EPAWs become unavailable (e.g., the EPAWs cannot be established and/or cannot be maintained), a system may implement a break-glass mechanism for providing access to the production workstations. FIG. 7 illustrates an example system arrangement 700, according to at least one embodiment. For example, the system arrangement 700 illustrates example break-glass operation for a system implementing EPAWs as described throughout this disclosure.

The system arrangement 700 may include a client device 702. The client device 702 may include one or more of the features of the client device 102 (FIG. 1), the user device 302 (FIG. 3), and/or the client device 502 (FIG. 5). The client device 702 may be configured to connect to one or more production workstations via EPAWs during full operation.

The system arrangement 700 may further include one or more possible EPAW instances. For example, the system arrangement 700 includes a first possible EPAW instance 704 and a second possible EPAW instance 706 in the illustrated embodiment. Each of the possible EPAW instances may represent an instance where an EPAW may be established and/or maintained during full operation. However, the possible EPAW instances may be unable to establish and/or maintain an EPAW during reduced operation, such as when EPAWs become unavailable. In the illustrated embodiment, the first possible EPAW instance 704 and the second possible EPAW instance 706 are unavailable, as shown by the X's over the first possible EPAW instance 704 and the second possible EPAW instance 706.

A user of the client device 702 may request that the client device 702 establish a connection a production workstation. In accordance with the procedure for the system being in full operation, the client device 702 may request establishment of a first EPAW at the first possible EPAW instance 704 and a second EPAW at the second possible EPAW instance 706 for establishing a connection with the production. However, since the EPAWs are unavailable at the first possible EPAW instance 704 and at the second possible EPAW instance 706, the client device 702 may not receive responses to the establishment requests within a time out period, and/or may receive an indication that EPAWs are unavailable. In other instances, the client device 702 may be aware that the EPAWs are unavailable when the user requests establishment, in which case the client device 702 may not send requests for establishment of EPAWs and may proceed with break-glass operation.

The client device 702 may determine that EPAWs are unavailable, such as by not receiving the response within the time out period or receiving the indication that the EPAWs are unavailable. Based on the client device 702 determining that EPAWs are unavailable, the client device 702 may determine that break-glass operation is to be implemented for establishing a connection with the production workstation. During break-glass operation, the client device 702 may send requests for connecting to the production workstation directly to the bastion.

The system arrangement 700 may include one or more bastions for establishing connections to production workstations. In the illustrated embodiment, the system arrangement 700 includes a bastion 708.

The system arrangement 700 may include one or more production workstations. In the illustrated embodiment, the system arrangement 700 includes a production host 712. The bastion 708 may be coupled to the production host 712 and may facilitate connections with the production host 712.

The client device 702 may transmit requests for connections to the production workstations directly to the bastions due to the EPAWs being unavailable. For example, the client device 702 may transmit a request for connection to the production host 712 directly to the bastion 708. The requests may request break-glass certificates for accessing the bastions directly. Based on the requests, the bastion 708 may generate a first break-glass certificate for accessing the bastion 708, and the bastion 708 may provide the break-glass certificates to the client device 702.

The client device 702 may utilize the break-glass certificates to access the bastion 708. The bastion 708 may provide the client device 702 with access to the production host 712.

One or more of the approaches described throughout this disclosure can be implemented by a cloud system for providing access to production workstations. The approaches can provide protection for the production workstations from bad actors. For example, the EPAWs can protect against bad actors obtaining keys for accessing the production workstations, and/or installing virus and/or other programs on the production workstations that could obtain sensitive data from the production workstations.

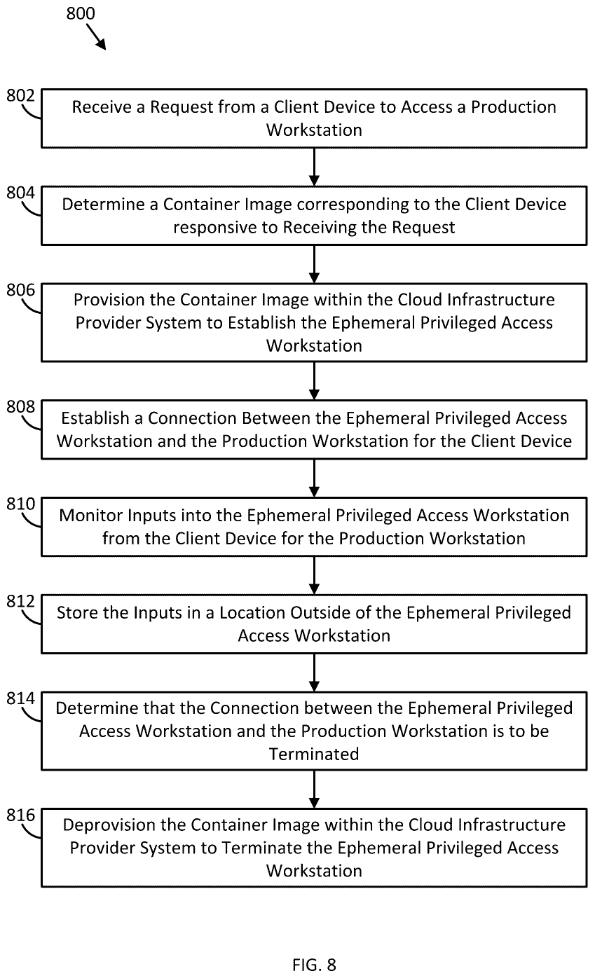

FIG. 8 illustrate an example procedure 800 for providing access to production workstations via EPAWs, according to at least one embodiment. The procedure 800 is illustrated as a logical flow diagram, each operation of which can be implemented in hardware, computer instructions, or a combination thereof. In the context of computer instructions, the operations may represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the process. The procedure 800 may be performed by an infrastructure (such as XXX), a cloud infrastructure provider system (such as the cloud infrastructure provider system arrangement 200 (FIG. 2)), a cloud service provider (such as the cloud service provider 504 (FIG. 5) and/or the cloud service provider 632 (FIG. 6)), and/or some portion thereof. For brevity, the procedure 800 is described herein as being performed by a cloud service provider system.

In 802, the cloud service provider system may receive a request from a client device to access the production workstation. In particular, a client device (such as the client device 102 (FIG. 1), the client device 502 (FIG. 5), and/or the client device 702 (FIG. 7)) may generate a request for accessing a production workstation. The client device may transmit the request to the cloud service provider system. The cloud service provider system may receive the request from the client device.

In 804, the cloud service provider system may determine a container image corresponding to the client device responsive to receiving the request. The container image may include configurations and policies for accessing the production workstation.

In 806, the cloud service provider system may provision the container image within the cloud infrastructure provider system to establish the ephemeral privileged access workstation. For example, the provisioning of the container image may cause an ephemeral privileged access workstation (such as the EPAWs 104 (FIG. 1), the EPAW 216 (FIG. 2), the EPAW 528 (FIG. 5), and/or the EPAW 604 (FIG. 6)) to be established. The cloud service provider system may provision the container image responsive to receiving the request in 802. In some embodiments, the ephemeral privileged access workstation may be established in a first subnet of the cloud infrastructure provider system. Further, the ephemeral privileged access workstation may be prevented from accessing the internet in some embodiments.

In some embodiments, the cloud service provider system may assign an identifier to the ephemeral privileged access workstation after establishment of the ephemeral privileged access workstation and establishment of a monitoring element for monitoring the inputs into the ephemeral privileged access workstation. The cloud service provider system may further provide the identifier to the client device for communicating with the ephemeral privileged access workstation.

In 808, the cloud service provider system may establish a connection between the ephemeral privileged access workstation and the production workstation for the client device. In some embodiments, establishing the connection between the EPAW and the production workstation may include establishing a connection between the ephemeral privileged access workstation and an egress element utilized for accessing the production workstation. The egress element may be located in a separate subnet of the cloud infrastructure provider system from the ephemeral privileged access workstation.

In some embodiments, the procedure 800 may include receiving, by a monitoring element for monitoring the inputs into the ephemeral privileged access workstation, a first secure shell (SSH) protocol certificate from the client device. Further, the monitoring element may verify that the client device is authorized to access the production workstation based at least in part on the first SSH protocol certificate. The monitoring element may generate a second SSH protocol certificate. The monitoring element may further provide the second SSH protocol certificate to the ephemeral privileged access workstation. The ephemeral privileged access workstation may verify that the client device is authorized to access the production workstation based at least in part on the second SSH protocol certificate. The cloud service provider may provide the client device access to the ephemeral privileged access workstation based at least in part on the monitoring element and the ephemeral privileged access workstation verifying that the client device is authorized to access the production workstation.

In 810, the cloud service provider system may monitor inputs into the ephemeral privileged access workstation from the client device for the production workstation. The inputs may include keystrokes of the client device and data received from the client device.

The inputs may be monitored by a monitoring element residing in a second subnet of the cloud infrastructure provider system. The monitoring element may capture the inputs prior to the inputs arriving at ephemeral privileged access workstation.

In 812, the cloud service provider system may store the inputs in a location outside of the ephemeral privileged access workstation. In some embodiments, the location where the inputs are stored may be located outside of the first subnet and the second subnet.

The cloud service provider system may monitor outputs of the ephemeral privileged access workstation to the production workstation in some embodiments. Further, the cloud service provider system may store the outputs in the location outside of the ephemeral privileged access workstation.

In 814, the cloud service provider system may determine that the connection between the ephemeral privileged access workstation and the production workstation is to be terminated. For example, the cloud service provider system may determine that the connection is to be terminated in accordance with any of the options described herein, including the client device terminating a session and/or an inactivity time expiring.

In 816, the cloud service provider system may deprovision the container image within the cloud infrastructure provider system to terminate the ephemeral privileged access workstation. The cloud service provider system may deprovision the container image responsive to determining that the connection is to be terminated. Deprovisioning the container image may terminate the ephemeral privileged access workstation established in 806.

While FIG. 8 may arguably imply an order of the operations of the procedure 800, it should be understood that one or more of the operations may be performed in a different order and/or one or more of the operations may be performed concurrently in embodiments. Further, it should be understood that one or more of the operations may be omitted from and/or one or more additional operations may be added to the procedure 800 in other embodiments.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running.

Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 9 is a block diagram 900 illustrating an example pattern of an IaaS architecture, according to at least one embodiment. Service operators 902 can be communicatively coupled to a secure host tenancy 904 that can include a virtual cloud network (VCN) 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 916 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively coupled to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But, cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Metadata that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users', or other customers', resources. Also, this embodiment may allow users or customers of the system to store databases privately without needing to rely on public Internet 954, which may not have a desired level of threat prevention, for storage.

In other embodiments, the LB subnet(s) 922 contained in the control plane VCN 916 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

FIG. 10 is a block diagram 1000 illustrating another example pattern of an IaaS architecture, according to at least one embodiment. Service operators 1002 (e.g., service operators 902 of FIG. 9) can be communicatively coupled to a secure host tenancy 1004 (e.g., the secure host tenancy 904 of FIG. 9) that can include a virtual cloud network (VCN) 1006 (e.g., the VCN 906 of FIG. 9) and a secure host subnet 1008 (e.g., the secure host subnet 908 of FIG. 9). The VCN 1006 can include a local peering gateway (LPG) 1010 (e.g., the LPG 910 of FIG. 9) that can be communicatively coupled to a secure shell (SSH) VCN 1012 (e.g., the SSH VCN 912 of FIG. 9) via an LPG 910 contained in the SSH VCN 1012. The SSH VCN 1012 can include an SSH subnet 1014 (e.g., the SSH subnet 914 of FIG. 9), and the SSH VCN 1012 can be communicatively coupled to a control plane VCN 1016 (e.g., the control plane VCN 916 of FIG. 9) via an LPG 1010 contained in the control plane VCN 1016. The control plane VCN 1016 can be contained in a service tenancy 1019 (e.g., the service tenancy 919 of FIG. 9), and the data plane VCN 1018 (e.g., the data plane VCN 918 of FIG. 9) can be contained in a customer tenancy 1021 that may be owned or operated by users, or customers, of the system.

The control plane VCN 1016 can include a control plane DMZ tier 1020 (e.g., the control plane DMZ tier 920 of FIG. 9) that can include LB subnet(s) 1022 (e.g., LB subnet(s) 922 of FIG. 9), a control plane app tier 1024 (e.g., the control plane app tier 924 of FIG. 9) that can include app subnet(s) 1026 (e.g., app subnet(s) 926 of FIG. 9), a control plane data tier 1028 (e.g., the control plane data tier 928 of FIG. 9) that can include database (DB) subnet(s) 1030 (e.g., similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g., the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g., the service gateway 936 of FIG. 9) and a network address translation (NAT) gateway 1038 (e.g., the NAT gateway 938 of FIG. 9). The control plane VCN 1016 can include the service gateway 1036 and the NAT gateway 1038.

The control plane VCN 1016 can include a data plane mirror app tier 1040 (e.g., the data plane mirror app tier 940 of FIG. 9) that can include app subnet(s) 1026. The app subnet(s) 1026 contained in the data plane mirror app tier 1040 can include a virtual network interface controller (VNIC) 1042 (e.g., the VNIC of 942) that can execute a compute instance 1044 (e.g., similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g., the data plane app tier 946 of FIG. 9) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g., the metadata management service 952 of FIG. 9) that can be communicatively coupled to public Internet 1054 (e.g., public Internet 954 of FIG. 9). Public Internet 1054 can be communicatively coupled to the NAT gateway 1038 contained in the control plane VCN 1016. The service gateway 1036 contained in the control plane VCN 1016 can be communicatively coupled to cloud services 1056 (e.g., cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, that are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 9,” may be located in Region 1 and in “Region 2.” If a call to Deployment 9 is made by the service gateway 1036 contained in the control plane VCN 1016 located in Region 1, the call may be transmitted to Deployment 9 in Region 1. In this example, the control plane VCN 1016, or Deployment 9 in Region 1, may not be communicatively coupled to, or otherwise in communication with, Deployment 9 in Region 2.

FIG. 11 is a block diagram 1100 illustrating another example pattern of an IaaS architecture, according to at least one embodiment. Service operators 1102 (e.g., service operators 902 of FIG. 9) can be communicatively coupled to a secure host tenancy 1104 (e.g., the secure host tenancy 904 of FIG. 9) that can include a virtual cloud network (VCN) 1106 (e.g., the VCN 906 of FIG. 9) and a secure host subnet 1108 (e.g., the secure host subnet 908 of FIG. 9). The VCN 1106 can include an LPG 1110 (e.g., the LPG 910 of FIG. 9) that can be communicatively coupled to an SSH VCN 1112 (e.g., the SSH VCN 912 of FIG. 9) via an LPG 1110 contained in the SSH VCN 1112. The SSH VCN 1112 can include an SSH subnet 1114 (e.g., the SSH subnet 914 of FIG. 9), and the SSH VCN 1112 can be communicatively coupled to a control plane VCN 1116 (e.g., the control plane VCN 916 of FIG. 9) via an LPG 1110 contained in the control plane VCN 1116 and to a data plane VCN 1118 (e.g., the data plane 918 of FIG. 9) via an LPG 1110 contained in the data plane VCN 1118. The control plane VCN 1116 and the data plane VCN 1118 can be contained in a service tenancy 1119 (e.g., the service tenancy 919 of FIG. 9).

The control plane VCN 1116 can include a control plane DMZ tier 1120 (e.g., the control plane DMZ tier 920 of FIG. 9) that can include load balancer (LB) subnet(s) 1122 (e.g., LB subnet(s) 922 of FIG. 9), a control plane app tier 1124 (e.g., the control plane app tier 924 of FIG. 9) that can include app subnet(s) 1126 (e.g., similar to app subnet(s) 926 of FIG. 9), a control plane data tier 1128 (e.g., the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 9) and a network address translation (NAT) gateway 1138 (e.g., the NAT gateway 938 of FIG. 9). The control plane VCN 1116 can include the service gateway 1136 and the NAT gateway 1138.

The data plane VCN 1118 can include a data plane app tier 1146 (e.g., the data plane app tier 946 of FIG. 9), a data plane DMZ tier 1148 (e.g., the data plane DMZ tier 948 of FIG. 9), and a data plane data tier 1150 (e.g., the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g., public Internet 954 of FIG. 9).

The Internet gateway 1134 contained in the control plane VCN 1116 and contained in the data plane VCN 1118 can be communicatively coupled to a metadata management service 1152 (e.g., the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

FIG. 12 is a block diagram 1200 illustrating another example pattern of an IaaS architecture, according to at least one embodiment. Service operators 1202 (e.g., service operators 902 of FIG. 9) can be communicatively coupled to a secure host tenancy 1204 (e.g., the secure host tenancy 904 of FIG. 9) that can include a virtual cloud network (VCN) 1206 (e.g., the VCN 906 of FIG. 9) and a secure host subnet 1208 (e.g., the secure host subnet 908 of FIG. 9). The VCN 1206 can include an LPG 1210 (e.g., the LPG 910 of FIG. 9) that can be communicatively coupled to an SSH VCN 1212 (e.g., the SSH VCN 912 of FIG. 9) via an LPG 1210 contained in the SSH VCN 1212. The SSH VCN 1212 can include an SSH subnet 1214 (e.g., the SSH subnet 914 of FIG. 9), and the SSH VCN 1212 can be communicatively coupled to a control plane VCN 1216 (e.g., the control plane VCN 916 of FIG. 9) via an LPG 1210 contained in the control plane VCN 1216 and to a data plane VCN 1218 (e.g., the data plane 918 of FIG. 9) via an LPG 1210 contained in the data plane VCN 1218. The control plane VCN 1216 and the data plane VCN 1218 can be contained in a service tenancy 1219 (e.g., the service tenancy 919 of FIG. 9).

The control plane VCN 1216 can include a control plane DMZ tier 1220 (e.g., the control plane DMZ tier 920 of FIG. 9) that can include LB subnet(s) 1222 (e.g., LB subnet(s) 922 of FIG. 9), a control plane app tier 1224 (e.g., the control plane app tier 924 of FIG. 9) that can include app subnet(s) 1226 (e.g., app subnet(s) 926 of FIG. 9), a control plane data tier 1228 (e.g., the control plane data tier 928 of FIG. 9) that can include DB subnet(s) 1230 (e.g., DB subnet(s) 1130 of FIG. 11). The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 9) and a network address translation (NAT) gateway 1238 (e.g., the NAT gateway 938 of FIG. 9). The control plane VCN 1216 can include the service gateway 1236 and the NAT gateway 1238.

The data plane VCN 1218 can include a data plane app tier 1246 (e.g., the data plane app tier 946 of FIG. 9), a data plane DMZ tier 1248 (e.g., the data plane DMZ tier 948 of FIG. 9), and a data plane data tier 1250 (e.g., the data plane data tier 950 of FIG. 9). The data plane DMZ tier 1248 can include LB subnet(s) 1222 that can be communicatively coupled to trusted app subnet(s) 1260 (e.g., trusted app subnet(s) 1160 of FIG. 11) and untrusted app subnet(s) 1262 (e.g., untrusted app subnet(s) 1162 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N), and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g., public Internet 954 of FIG. 9).

The Internet gateway 1234 contained in the control plane VCN 1216 and contained in the data plane VCN 1218 can be communicatively coupled to a metadata management service 1252 (e.g., the metadata management system 952 of FIG. 9) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively coupled to cloud services 1256.

In some examples, the pattern illustrated by the architecture of block diagram 1200 of FIG. 12 may be considered an exception to the pattern illustrated by the architecture of block diagram 1100 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

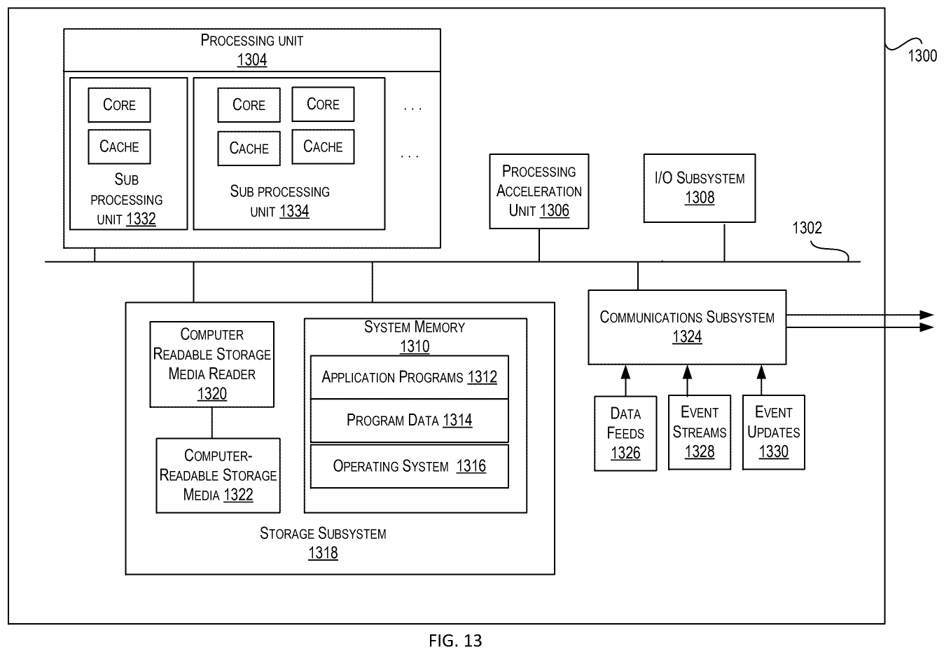

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may comprise a storage subsystem 1318 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1304 provide the functionality described above. Storage subsystem 1318 may also provide a repository for storing data used in accordance with the present disclosure.

As depicted in the example in FIG. 13, storage subsystem 1318 can include various components including a system memory 1310, computer-readable storage media 1322, and a computer readable storage media reader 1320. System memory 1310 may store program instructions that are loadable and executable by processing unit 1304. System memory 1310 may also store data that is used during the execution of the instructions and/or data that is generated during the execution of the program instructions. Various different kinds of programs may be loaded into system memory 1310 including but not limited to client applications, Web browsers, mid-tier applications, relational database management systems (RDBMS), virtual machines, containers, etc.

System memory 1310 may also store an operating system 1316. Examples of operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1300 executes one or more virtual machines, the virtual machines along with their guest operating systems (GOSs) may be loaded into system memory 1310 and executed by one or more processors or cores of processing unit 1304.

System memory 1310 can come in different configurations depending upon the type of computer system 1300. For example, system memory 1310 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1310 may include a basic input/output system (BIOS) containing basic routines that help to transfer information between elements within computer system 1300, such as during start-up.

Computer-readable storage media 1322 may represent remote, local, fixed, and/or removable storage devices plus storage media for temporarily and/or more permanently containing, storing, computer-readable information for use by computer system 1300 including instructions executable by processing unit 1304 of computer system 1300.

Computer-readable storage media 1322 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Machine-readable instructions executable by one or more processors or cores of processing unit 1304 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method of hosting an ephemeral privileged access workstation via a cloud infrastructure provider system for providing access to a production workstation, comprising:
receiving a request from a client device to access the production workstation;
determining a container image corresponding to the client device responsive to receiving the request, the container image including configurations and policies for accessing the production workstation;
responsive to receiving the request, provisioning the container image within the cloud infrastructure provider system to establish the ephemeral privileged access workstation;
establishing a connection between the ephemeral privileged access workstation and the production workstation for the client device;
monitoring inputs into the ephemeral privileged access workstation from the client device for the production workstation;
storing the inputs in a location outside of the ephemeral privileged access workstation;
determining that the connection between the ephemeral privileged access workstation and the production workstation is to be terminated; and
responsive to determining that the connection is to be terminated, deprovisioning the container image within the cloud infrastructure provider system to terminate the ephemeral privileged access workstation.

2. The method of claim 1, wherein the inputs include keystrokes of the client device and data received from the client device.

3. The method of claim 1, wherein the ephemeral privileged access workstation is established in a first subnet of the cloud infrastructure provider system, and wherein the inputs are monitored by a monitoring element residing in a second subnet of the cloud infrastructure provider system.

4. The method of claim 3, wherein the monitoring element captures the inputs prior to the inputs arriving at the ephemeral privileged access workstation.

5. The method of claim 3, wherein the location where the inputs are stored is located outside of the first subnet and the second subnet.

6. The method of claim 1, further comprising:
assigning an identifier to the ephemeral privileged access workstation after establishment of the ephemeral privileged access workstation and establishment of a monitoring element for monitoring the inputs into the ephemeral privileged access workstation; and
providing the identifier to the client device for communicating with the ephemeral privileged access workstation.

7. The method of claim 1, further comprising:
receiving, by a monitoring element for monitoring the inputs into the ephemeral privileged access workstation, a first secure shell (SSH) protocol certificate from the client device;
verifying, by the monitoring element, that the client device is authorized to access the production workstation based at least in part on the first SSH protocol certificate;
generating, by the monitoring element, a second SSH protocol certificate;
providing, by the monitoring element, the second SSH protocol certificate to the ephemeral privileged access workstation;
verifying, by the ephemeral privileged access workstation, that the client device is authorized to access the production workstation based at least in part on the second SSH protocol certificate; and
providing the client device access to the ephemeral privileged access workstation based at least in part on the monitoring element and the ephemeral privileged access workstation verifying that the client device is authorized to access the production workstation.

8. The method of claim 1, wherein establishing the connection between the ephemeral privileged access workstation and the production workstation comprises establishing a connection between the ephemeral privileged access workstation and an egress element utilized for accessing the production workstation.

9. The method of claim 8, wherein the egress element is located in a separate subnet of the cloud infrastructure provider system from the ephemeral privileged access workstation.

10. The method of claim 1, further comprising:
monitoring outputs of the ephemeral privileged access workstation to the production workstation; and
storing the outputs in the location outside of the ephemeral privileged access workstation.

11. The method of claim 1, wherein the ephemeral privileged access workstation is prevented from accessing the Internet.

12. One or more non-transitory computer-readable media having instructions stored thereon, wherein the instructions, when executed by one or more processors of a cloud infrastructure provider system, cause the one or more processors to:
receive a request from a client device to access a production workstation;
determine a container image corresponding to the client device responsive to receiving the request, the container image including configurations and policies for accessing the production workstation;
responsive to receiving the request, provision the container image within the cloud infrastructure provider system to establish an ephemeral privileged access workstation that provides access to the production workstation;
establish a connection between the ephemeral privileged access workstation and the production workstation for the client device;
monitor inputs into the ephemeral privileged access workstation from the client device for the production workstation;
store the inputs in a location outside of the ephemeral privileged access workstation;
determine that the connection between the ephemeral privileged access workstation and the production workstation is to be terminated; and
responsive to determining that the connection is to be terminated, deprovision the container image within the cloud infrastructure provider system to terminate the ephemeral privileged access workstation.

13. The one or more non-transitory computer-readable media of claim 12, wherein the ephemeral privileged access workstation is established in a first subnet of the cloud infrastructure provider system, and wherein the inputs are monitored by a monitoring element residing in a second subnet of the cloud infrastructure provider system.

14. The one or more non-transitory computer-readable media of claim 13, wherein the monitoring element captures the inputs prior to the inputs arriving at the ephemeral privileged access workstation.

15. The one or more non-transitory computer-readable media of claim 13, wherein the location where the inputs are stored is located outside of the first subnet and the second subnet.

16. The one or more non-transitory computer-readable media of claim 12, wherein the instructions, when executed by the one or more processors, further cause the one or more processors to:
assign an identifier to the ephemeral privileged access workstation after establishment of the ephemeral privileged access workstation and establishment of a monitoring element for monitoring the inputs into the ephemeral privileged access workstation; and
provide the identifier to the client device for communicating with the ephemeral privileged access workstation.

17. The one or more non-transitory computer-readable media of claim 12, wherein the instructions, when executed by the one or more processors, further cause the one or more processors to:
receive, by a monitoring element for monitoring the inputs into the ephemeral privileged access workstation, a first secure shell (SSH) protocol certificate from the client device;
verify, by the monitoring element, that the client device is authorized to access the production workstation based at least in part on the first SSH protocol certificate;
generate, by the monitoring element, a second SSH protocol certificate;
provide, by the monitoring element, the second SSH protocol certificate to the ephemeral privileged access workstation;
verify, by the ephemeral privileged access workstation, that the client device is authorized to access the production workstation based at least in part on the second SSH protocol certificate; and
provide the client device access to the ephemeral privileged access workstation based at least in part on the monitoring element and the ephemeral privileged access workstation verifying that the client device is authorized to access the production workstation.

18. A cloud infrastructure provider system, comprising:
a gateway accessible by a client device for providing access to the cloud infrastructure provider system; and
one or more processors coupled to the gateway, the one or more processors to:
receive a request from the client device to access a production workstation;
determine a container image corresponding to the client device responsive to receiving the request, the container image including configurations and policies for accessing the production workstation;
responsive to receiving the request, provision the container image within the cloud infrastructure provider system to establish an ephemeral privileged access workstation that provides access to the production workstation;
establish a connection between the ephemeral privileged access workstation and the production workstation for the client device;
monitor inputs into the ephemeral privileged access workstation from the client device for the production workstation;
store the inputs in a location outside of the ephemeral privileged access workstation;
determine that the connection between the ephemeral privileged access workstation and the production workstation is to be terminated; and
responsive to determining that the connection is to be terminated, deprovision the container image within the cloud infrastructure provider system to terminate the ephemeral privileged access workstation.

19. The cloud infrastructure provider system of claim 18, wherein the ephemeral privileged access workstation is established in a first subnet of the cloud infrastructure provider system, and wherein the inputs are monitored by a monitoring element residing in a second subnet of the cloud infrastructure provider system.

20. The cloud infrastructure provider system of claim 18, wherein the ephemeral privileged access workstation is prevented from accessing the internet.
